(19) United States
(12) Patent Application Publication
(10) Pub. No.: US 2005/0221821 A1
(43) Pub. Date: Oct. 6, 2005

(54) Selectively enabling communications at a user interface using a profile

(76) Inventors: Raymond L. Sokola, Long Grove, IL (US); Michael A. Newell, Williams Bay, WI (US); Robert F. D'Avello, Lake Zurich, IL (US); Scott B. Davis, Walworth, WI (US); Nick J. Grivas, Harvard, IL (US); Jerome D. Meyerhoff, Buffalo Grove, IL (US); James A. Van Bosch, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 10/818,077

(22) Filed: Apr. 5, 2004

(51) Int. Cl. H04Q 7/20

(52) U.S. Cl. 455/432.3

(57) ABSTRACT

A system and method for selectively enabling communications at a user interface using a user profile. The system and methods have particular utility to communication user interfaces in vehicles but may be used with other wireless user interfaces as well. In one embodiment, a user uses his user interface to define a user profile indicative of the types of communication channels he wishes to receive. This user profile is transmitted to a communications server and is used to filter all potential channels so that the user only has access to those channels potentially of interest. User preferences specified in the user profile may be, for example, topical, commercial, weather, traffic, or emergency in nature, and can be stored for future reference. The user may also prioritize preferred or received channels so that they are given precedence at his user interface. In this regard, activation of priority channels may present the user a notification informing the user of the priority channel and allowing him to join, or the priority channel may be automatically activated at the user interface without further user involvement. In an additional embodiment, the user profile may constitute or be supplemented by data indicative of the user interface in question. For example, a VIN number associated with a vehicular user interface can be used to filter for channels having pertinence to the vehicle in question.

The present application is related to the following co-pending, commonly assigned patent applications, which were filed concurrently herewith and incorporated by reference in their entirety:

Ser. No. ______, entitled “Method for Enabling Communications Dependent on User Location, User-Specified Location, or Orientation,” attorney docket TC00168, filed concurrently herewith.

Ser. No. ______, entitled “Methods for Sending Messages Based on the Location of Mobile Users in a Communication Network,” attorney docket TC00169, filed concurrently herewith.

Ser. No. ______, entitled “Methods for Displaying a Route Traveled by Mobile Users in a Communication Network,” attorney docket TC00170, filed concurrently herewith.

Ser. No. ______, entitled “Conversion of Calls from an Ad Hoc Communication Network,” attorney docket TC00172, filed concurrently herewith.

Ser. No. ______, entitled “Method for Entering a Personalized Communication Profile Into a Communication User Interface,” attorney docket TC00173, filed concurrently herewith.

Ser. No. ______, entitled “Methods and Systems for Controlling Communications in an Ad Hoc Communication Network,” attorney docket TC00174, filed concurrently herewith.

Ser. No. ______, entitled “Methods for Controlling Processing of Inputs to a Vehicle Wireless Communication Interface,” attorney docket TC00175, filed concurrently herewith.

Ser. No. ______, entitled “Methods for Controlling Processing of Outputs to a Vehicle Wireless Communication Interface,” attorney docket TC00176, filed concurrently herewith.

Ser. No. ______, entitled “Programmable Foot Switch Useable in a Communications User Interface in a Vehicle,” attorney docket TC00177, filed concurrently herewith.

### FIELD OF THE INVENTION

This invention relates to a system and method for organizing communications in an ad hoc communication network, and more specifically in a vehicle.

### BACKGROUND OF THE INVENTION

Communication systems, and especially wireless communication systems, are becoming more sophisticated, offering consumers improved functionality to communicate with one another. Such increased functionality has been particularly useful in the automotive arena, and vehicles are now being equipped with communication systems with improved audio (voice) wireless communication capabilities. For example, On Starm is a well-known communication system currently employed in vehicles, and allows vehicle occupants to establish a telephone call with others (such as a service center) by activating a switch.

It is anticipated that most vehicles in the future will have some type of wireless communication device. As the number of vehicles with wireless communication devices increases, consumers will demand additional services and features. For instance, it is anticipated that consumers will desire to hold group conversation between vehicles. In such an environment, many group conversations might be held, with a wide variance in interests, each on its own channel. Thus, a user could find himself overwhelmed at the conversation options and channels open to him. For example, if all such group conversation options are listed on a display in a user interface, such a listing may become so long as to become useless. Moreover, many of the group conversations may not be of interest to particular user, who would therefore merely find the presentation of such conversation channels annoying and distracting in a search to find conversations of interest.

In short, a need exists for the management and organization of vehicle wireless-based communications systems to enhance its functionality, and to better utilize the resources that the system is capable of providing. This disclosure presents several different means to so improve these communications.

It is, therefore, desirable to provide a system and procedure for organizing communications in an ad hoc communication network, and more specifically in a vehicle.

### BRIEF DESCRIPTION OF THE DRAWINGS

FIG. 1 is a block diagram of a wireless vehicular communications system;

FIG. 2 is a block diagram of a control system for a vehicular wireless communications system;

FIG. 3a is a diagram illustrating a plurality of communication channels at a server accessible by users of the system;

FIG. 3b is a diagram illustrating a plurality of users which can potentially receive the channels of FIG. 3b;

FIG. 4a is one embodiment of a display in a user's interface for setting up a user profile for receiving some subset of the channels handled by the system;

FIG. 4b is one embodiment of a display showing the presentation of channels to the user after processing of the channels by his user profile;

FIG. 5 illustrates the definition of a new system channel by a user, including the specification of channel properties;

FIG. 6 illustrates how users can specify the priority of channels they receive;

FIG. 7 illustrates notification at a user interface of a higher priority channel, and allowing a user to join that priority channel; and

FIG. 8 illustrates selection of a plurality of channels having a relation to a particular vehicle model and/or its VIN number.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is a system and procedure for organizing communications in an ad hoc communication network. The system and methods have particular utility to communication user interfaces in vehicles but may be used with other wireless user interfaces as well. In one embodiment, a user uses his user interface to define a user profile indicative of the types of communication channels he wishes to receive. This user profile is transmitted to a communications server and is used to filter all potential channels so that the user only has access to those channels potentially of interest. User preferences specified in the user profile may be, for example, topical, commercial, weather, traffic, or emergency in nature, and can be stored for future reference. The user may also prioritize preferred or received channels so that they are given precedence at his user interface. In this regard, activation of priority channels may present the user a notification informing the user of the priority channel and allowing him to join, or the priority channel may be automatically activated at the user interface without further user involvement. In an additional embodiment, the user profile may constitute or be supplemented by data indicative of the user interface in question. For example, a VIN number associated with a vehicular user interface can be used to filter for channels having pertinence to the vehicle in question.

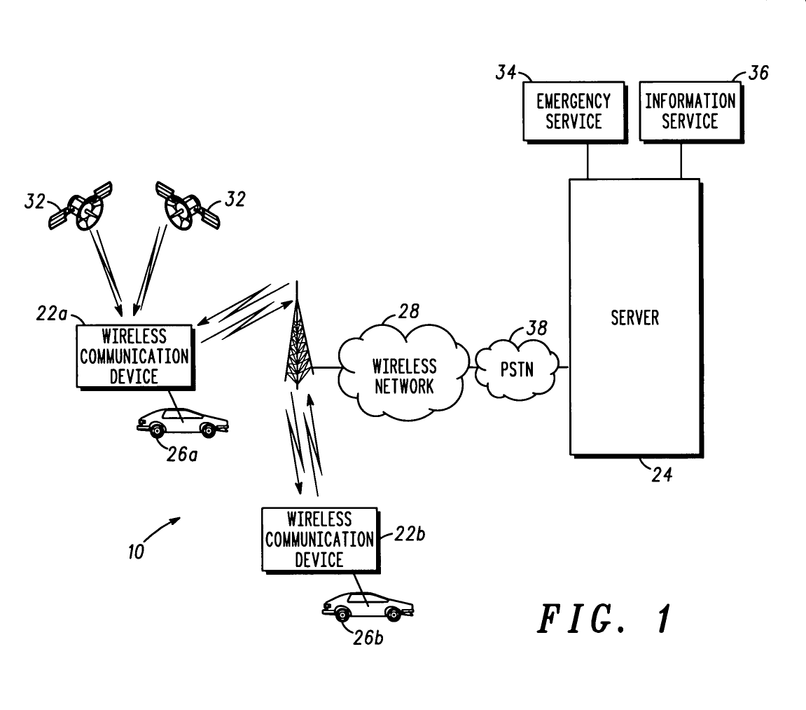

Now, turning to the drawings, an example use of the present invention in an automotive setting will be explained. FIG. 1 shows an exemplary vehicle-based communication system 10. In this system, vehicles 26 are equipped with wireless communication devices 22, which will be described in further detail below. The communication device 22 is capable of sending and receiving voice (i.e., speech), data (such as textual or SMS data), and/or video. Thus, device 22 can wirelessly transmit or receive any of these types of information to a transceiver or base station coupled to a wireless network 28. Moreover, the wireless communication device may receive information from satellite communications. Ultimately, the network may be coupled to a public switched telephone network (PSTN) 38, the Internet, or other communication network on route to a server 24, which ultimately acts as the host for communications on the communication system 10 and may comprise a communications server. As well as administering communications between vehicles 26 wirelessly connected to the system, the server 24 can be part of a service center that provides other services to the vehicles 26, such as emergency services 34 or other information services 36 (such as restaurant services, directory assistance, etc.).

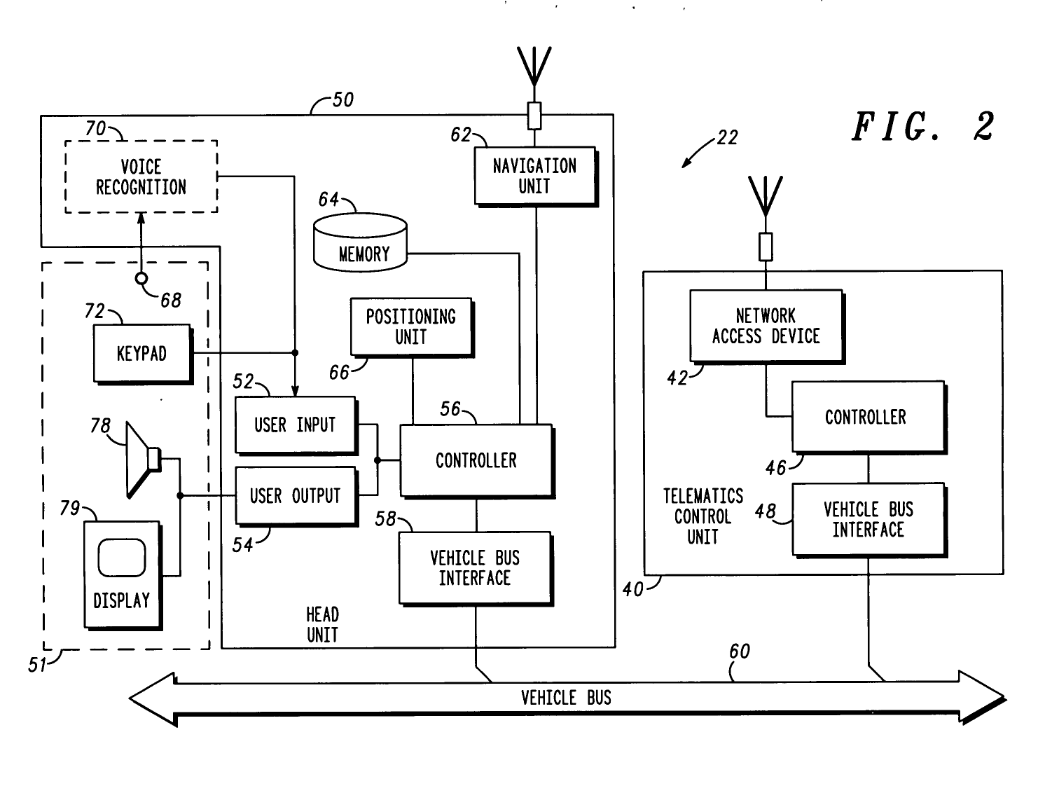

Further details of a typical wireless communications device 22 as employed in a vehicle 26 are shown in FIG. 2. In one embodiment, the device 22 is comprised of two main components: a head unit 50 and a Telematics control unit 40. The head unit 50 interfaces with or includes a user interface 51 with which the vehicle occupants interact when communicating with the system 10 or other vehicles coupled to the system. For example, a microphone 68 can be used to pick up a speaker's voice in the vehicle, and/or possibly to give commands to the head unit 50 if it is equipped with a voice recognition module 70. A keypad 72 may also be used to provide user input, with switches on the keypad 72 either being dedicated to particular functions (such as a push-to-talk switch, a switch to receive mapping information, etc.) or allowing for selection of options that the user interface provides.

The head unit 50 also comprises a navigation unit 62, which typically includes a Global Positioning Satellite (GPS) system for allowing the vehicle's location to be pinpointed, which is useful, for example, in associating the vehicle's location with mapping information the system provides. As is known, such a navigation unit communicates with GPS satellites (such as satellites 32) via a receiver. Also present is a positioning unit 66, which determines the direction in which the vehicle is pointing (north, north-east, etc.), and which is also useful for mapping a vehicle's progress along a route.

Ultimately, user and system inputs are processed by a controller 56 which executes processes in the head unit 50 accordingly, and provides outputs 54 to the occupants in the vehicle, such as through a speaker 78 or a display 79 coupled to the head unit 50. The speakers 78 employed can be the audio (radio) speakers normally present in the vehicle, of which there are typically four or more, although only one is shown for convenience. Moreover, in an alternative embodiment, the output 54 may include a text to speech converter to provide the option to hear an audible output of any text that is contained in a group communication channel that the user may be monitoring. This audio feature may be particular advantageous in the mobile environment where the user is operating a vehicle. Additionally, a memory 64 is coupled to the controller 56 to assist it in performing regulation of the inputs and outputs to the system. The controller 56 also communicates via a vehicle bus interface 58 to a vehicle bus 60, which carries communication information and other vehicle operational data throughout the vehicle.

The Telematics control unit 40 is similarly coupled to the vehicle bus 60, via a vehicle bus interface 48, and hence the head unit 50. The Telematics control unit 40 is essentially responsible for sending and receiving voice or data communications to and from the vehicle, i.e., wirelessly to and from the rest of the communications system 10. As such, it comprises a Telematics controller 46 to organize such communications, and a network access device (NAD) 42 which include a wireless transceiver. Although shown as separate components, one skilled in the art will recognize that aspects of the head unit 50 and the Telematics control unit 40, and components thereof, can be combined or swapped.

The wireless communications device 22 can provide a great deal of communicative flexibility within vehicle 26. For example, an occupant in a first vehicle 26a can call a second vehicle 26b to speak to its occupants either by pressing a switch on the keypad 72 of the head unit 50 or by simply speaking if the head unit is equipped with a voice recognition module 70. In one embodiment, the pressing of a switch or speaking into a voice recognition module initiates a cellular telephone call with a second vehicle 26b. In this case, users in either the first vehicle 26a or the second vehicle 26b can speak with each other without pressing any further switches. Moreover, the system may be configured to include a voice activated circuit such as a voice activated switch (VAS) or voice operated transmit (VOX). This would also provide for hands-free operation of the system by a user when communicating with other users.

In an alternative embodiment, the switch may be configured to establish a push-to-talk communication channel over a cellular network. Here, the controller 56 is configured to only allow audio by occupants in the first vehicle 26a through microphone 68 to be transmitted through the Telematics control unit 40 when a user in the first vehicle 26a is pressing down on the push-to-talk switch. The controller 56 is further configured to only allow audio received from the second vehicle 26b (or server 24) to be heard over speakers 78 when the operator of the first vehicle 26a is not pressing down on the switch. Alternatively, to avoid the need of holding down a switch to speak, the system may be configured to allow a user to push a button a first time to transmit audio and push the button a second time to receive audio.

In any event, a user in the second vehicle 26b can, in like fashion, communicate back to the first vehicle 26a, with the speaker's voice being heard on speaker(s) 78 in the first vehicle. Or, an occupant in the first vehicle 26a can call the server 24 to receive services. Additionally, such a system 10 can have utility outside of the context of vehicle-based applications, and specifically can have utility with respect to other portable devices (cell phones, personal data assistants (PDAs), etc.).

System 10 can be used by a vehicle user to engage in group conversations, in what we will call an “ad hoc” communication network. In such an application, a plurality of users in communication with the system can join into a public conversation. Typically, in such a system, some subset of users is predefined by a system's user to form a communication group, such as a family group, a professional work group, etc. Once predefined, any of those predefined users can speak with other predefined users, for example, by pressing a push-to-talk button on their user interfaces, which again may constitute cell phones, PDAs, a dedicated vehicular user interface, etc. All other users in the predefined group will hear the voice of the speaking user, and in turn all users may likewise speak with the rest of the users in the group by pressing the buttons on their user interfaces.

In one embodiment, a user uses a communication user profile to tailor the communication channels he will receive at his user interface. The user profile can specify and scan for channels of interest to the user, including, for example: topical channels (e.g., Chicago Bears football, gardening, home repair); weather channels; emergency channels; commercial channels; and channels based on a particular location. In effect, the user profile is used as a filter to provide to particular user only those channels that are of interest to him. As will be disclosed further herein, such filtering may occur either from the user side, in which the user filters available channels on the system, or on the system side, in which the system scans for particular users of relevance to a given channel and only allowing participation of those users.

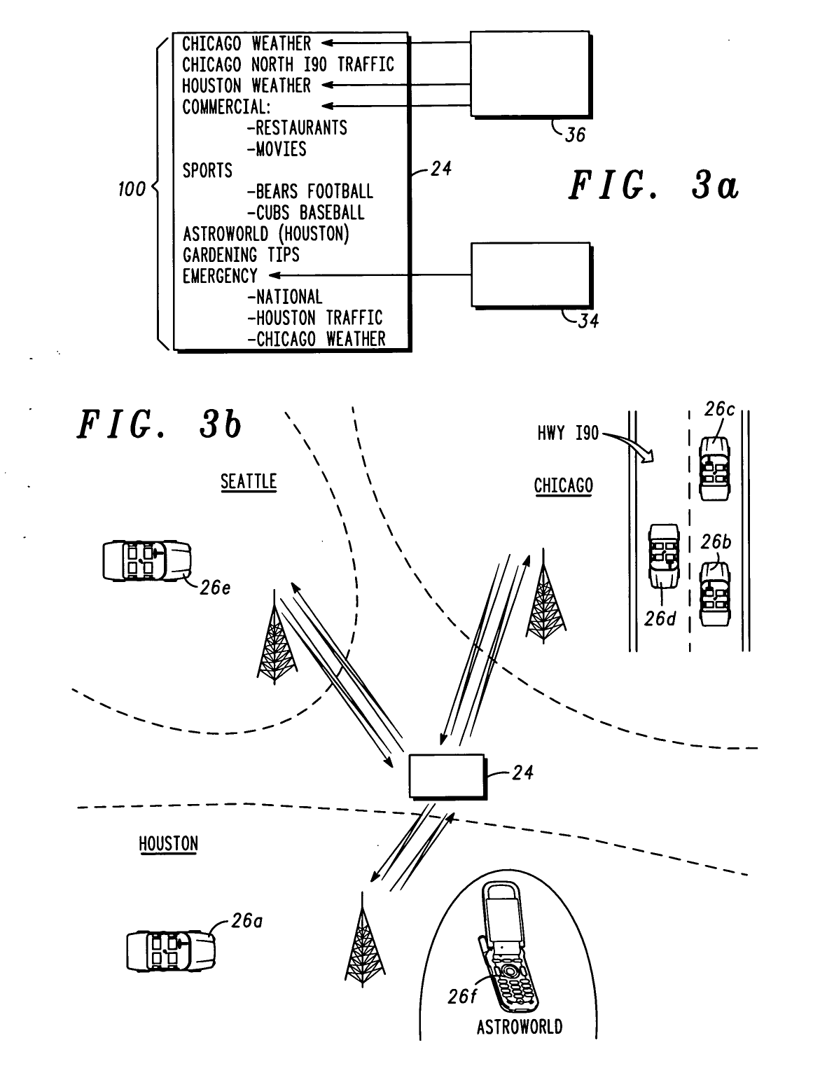

FIGS. 3a and 3b provide an exemplary public communication system for the purpose of illustrating many of the useful aspects of the disclosed system and method. As shown in FIG. 3a, the server 24 acts as the host for all of the various communication channels which are accessible on the system. Only a number of channels are shown for convenience and to illustrate various aspects of the invention. Some of the channels are sponsored by third party services (such as emergency services 34 or other information services 36) (“service channels”), while other channels are ad hoc channels established by the users of the system or by systems administrators (“user channels”). Thus for example, weather broadcasts channels for Houston and Chicago are shown, as is a national emergency channel; these service channels (for illustration purposes) provide communications with third party services, and may provide system users with the ability to have two way communications with the services, or simply to receive one way communications (akin to a simple broadcasting of a weather or national emergency message).

The other channels (user defined ad hoc channels) are envisioned as being communication channels set up by the users of the system for the benefit of other system users. Some of these user channels are topical (sports, gardening), some are specific to a particular area (the “Astroworld Amusement Park” in Houston), and some are particular to a specific area and/or direction (traffic northbound on Interstate 90 in Chicago), and others are emergency channels (Houston traffic, Chicago weather). The user channels allow users to communicate regarding the subject of the channel. For example, a Chicago weather channel may allow users to freely discuss weather conditions in Chicago that may present emergencies (e.g., snow storms or floods). Note also that there can also be a separate service channel for Chicago weather as well. Some of the channels may be grouped by the server 24 into logical sub groups. For example, “Sports” contains channels for both Chicago Bears football and Chicago Cubs baseball, while Emergencies are broken down into national emergencies (an emergency service channel) and Houston traffic and Chicago weather (emergency user channels).

Another example of a user initiated ad hoc communication channel would be a local traffic channel for a particular interstate or highway that a user may initiate to discuss a specific traffic accident. For instance, in one embodiment, the system (through server 24) would allow a first user that witnesses an accident to define an ad hoc group communication channel on a user interface. The first user could identify a user preference or category such as accidents and further identify a specific interstate or highway. Without regard to the location of either the first user or other users, the system would then allow a second user to use their user interface to join the group channel upon selection of the group channel from other groups that the second user is monitoring. The system would further permit the second user (and any other users who have joined the group channel) to talk with the first user by pushing a push-to-talk button coupled to their user interface, such as a push-to-talk button.

A further example of a user initiated ad hoc communication channel in a portable device environment would be for a field trip for a school. For instance, in one embodiment, the system (through server 24) would allow a first user (i.e. field trip organizer) to define an ad hoc group communication channel on a user interface on the portable device. The first user could identify a user preference or category such as a school field trip and further identify a specific park or museum. Without regard to the location of either the first user or other users, the system would then allow a second user to use their user interface to join the group channel upon selection of the group channel from other groups that the second user is monitoring. The system would further permit the second user (and any other users who have joined the group channel) to talk with the first user by pushing a button coupled to their user interface, such as a push-to-talk button.

FIG. 3b shows various users each able to potentially communicate with the system and along the channels disclosed in FIG. 3a. Six users (26a-26f) are shown in this simple example, each being located in three different regions of the country: Houston, Chicago, and Seattle. All users have user interfaces 51 similar to those disclosed in FIG. 2, except that user 26f's user interface 51 is contained within a cell phone (or other portable computer) and hence is not integral with a vehicle; it otherwise functions similarly to the user interfaces 51 in the vehicles absent of course functionality specific to vehicles. Users 26a and 26f are in Houston, and user 26f is located within an amusement park. Users 26b-d are in Chicago, and more specifically user 26b and c are traveling northbound on Interstate 90, while user 26d is traveling southbound. User 26e is in Seattle.

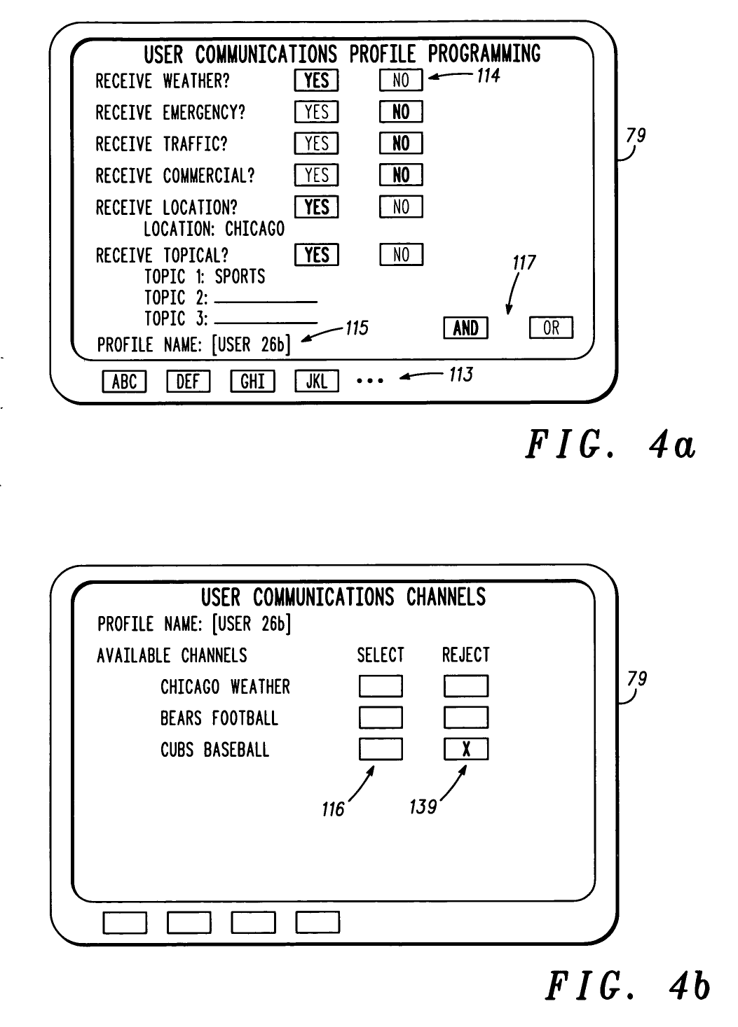

The various ways in which the users 26 can participate in or receive communications on these channels is illustrated below through the use of a user profile. First discussed is management of channel receipt by the end user, specifically user 26b in Chicago. That user may wish to hear only a certain subset of all of the communication channels 100 available on the system. For example, her involvement in communication groups outside of Chicago might not be of much interest. She may also wish to participate in (or merely receive) communications involving the weather and sports (of any kind). As shown in FIG. 4a, using the display 79 of her user interface 51, she can specify these preferences as shown. Such parameters can be entered in any number of ways using the user interface 51, but in the embodiment shown a combination of touch screen buttons 114 and alpha buttons 113 are user, the latter being used in a scheme similar to that used to enter names into cell phones as is well known. The user may also wish to enter her preferences through audible instructions through a voice recognition unit 70 in the head unit 50. In any event, user 26b makes her selections as shown. Entry of alphanumeric preferences (such as topics and locations) can be achieved using buttons 113 or other ways as discussed above. Ultimately, her user profile can be stored (e.g., under her name) for easy receipt, which can be stored in the memory 64 of the head unit 50 or at the server 24.

Of course, it may not be necessary to type (i.e., using button 113) textual information concerning the user's interests in defining the user profile. For example, the user could instead be presented with a list of available options (e.g., with states/cities listed in alphabetical order) from which the user can pick certain preferences.

Ultimately, once the user profile is defined in this or other manners, the information may be wirelessly sent to the server 24. The information is preferably sent as a header in a data stream, which may be accompanied by other useful data. Some user profile information may merely constitute toggling of a bit in the data header, particularly those requiring only yes/no answers such as receive weather, emergency, traffic, and commercial channels. Other more detailed information such as topic or location can be sent as text and handled on the server 24 end as appropriate. For example, if textual information is sent (such as a location), this text stream may be used at the server to query for appropriate channels (pertinent to that location) through the use of an appropriate search engine.

Either way, because the header information indicative of the user's communication preferences are provided in predictable formats, the server 24 can interpret these preferences to provided that user appropriate channels in accordance with those preferences. Thus, in accordance with the particular selections made in FIG. 4a, the sever 24 would pick for user 26b Chicago-based weather and sports channels, and broadcast these (and only these channels) to user 26b. In this regard, it should be noted that the user's profile (generated from FIG. 4a) is accompanied by the user's user ID, which again can be included in the header information broadcast to the server. The user ID can be included in the transmission by the controller 56 and can comprise a “handle,” a Vehicle Identification number (VIN), an Electronic Serial Number (ESN), an International Mobile Subscriber Number (IMSI), or a Mobile Subscriber International ISDN Number (MSISDN), all of which are referred to herein as “user IDs” for convenience. Receipt of the user ID at the server 24 allows the server to know where to send back the potential broadcast of channels.

Once the server 24 picks or filters appropriate channels in accordance with user 26b's preferences, the server 24 may then present those channels to user 26b. Accordingly, from the exemplary channels shown in FIG. 3a, and from the preferences specified in FIG. 4a, user 26b's display would provide to user 26b only the channels “Chicago Weather,” “Bears football,” and “Cubs baseball” as shown in FIGS. 4b, the latter two being Chicago-based sports teams and so appropriately indexed at the server 24. User 26b could then choose (again with touch screen buttons 116) to connect to one of these channels, either for the purpose of listening to the channel or participating in the group conversation taking place on that channel. After selecting a channel, user 26b could then use (for example) a push-to-talk button on his under interface 51 (not shown) to communicate on that channel.

Interpretation of the user preferences specified in FIG. 4a could also be further configurable by user 26b. For example, as discussed above, the server 24 essentially performs a logical “and” operation of the user's selection, such that weather and sports channels are chosen, and only in Chicago. But, the user may also allow the preferences to be logically “or-ed” (117, FIG. 4a) such that the user will receive all weather channels and sports channels, and any Chicago-based channels. Obviously, or-ing the user's selections would provide user 26b with many additional selectable channels.

Also shown in FIG. 4b is the ability of the user to reject certain channels despite the selection of channels made using the user profile. For example, even though user 26b has chosen to receive Chicago sports, she may not be a big baseball fan, and therefore may not wish to receive the “Cubs baseball” channel in the future. Accordingly, she may select the touch screen buttons 139 to defeat future receipt of this channel as shown. When such channel rejections are made, they are preferably stored along with the user profile ([user 26b]) so that the user is not bothered with this channel again in the future.

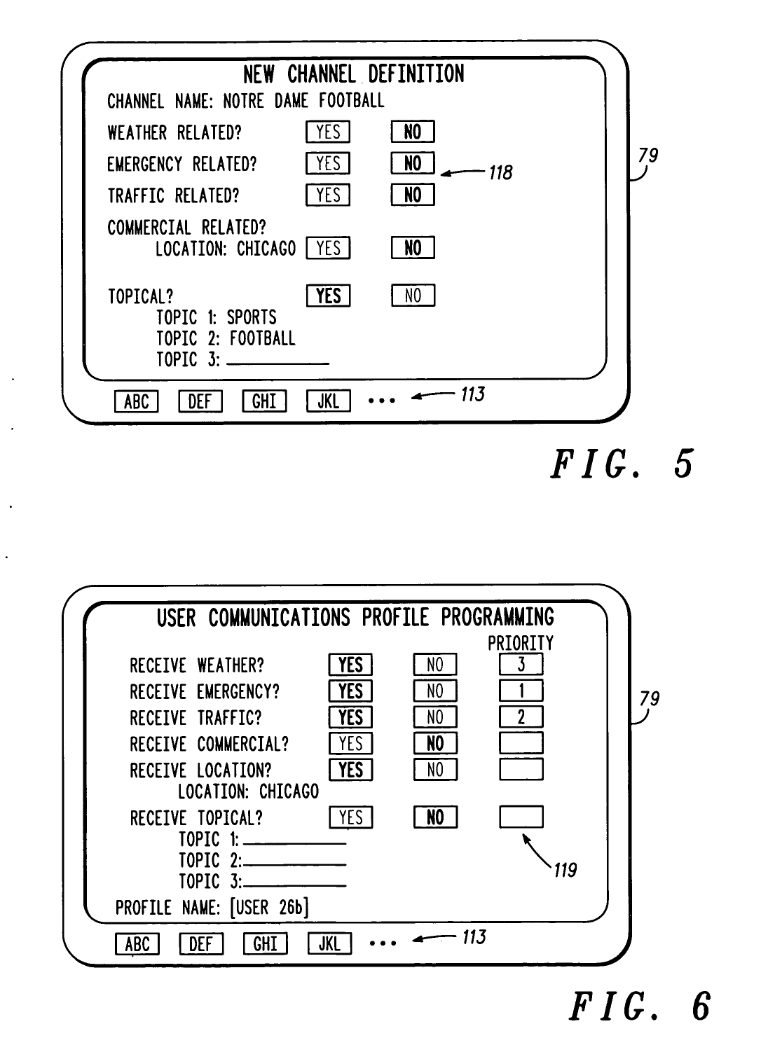

In another embodiment, the disclosed system may also be used by the system users to set up their own communication channels. For example, suppose user 26b searches the system for channels discussing Notre Dame Football. Finding none, that user could use the system to set up such a group conversation with an appropriate channel. To be a useful channel in the system, user 26b preferably specifies many of the same parameters that a user would use to set up his user profile to scan and filter for channels of interest (see FIG. 4a); in this way, the server 24 can appropriately index the newly-created channel in such a way that it will be easily selectable by another user's profile. Thus, for user 26b's Notre Dame football channel, and as shown in FIG. 5, that user specifies that the new channel's name, and its characteristics, i.e., that it is a topical sports/football channel (as opposed to a weather, emergency, traffic, or commercial channel). Thus user further specifies that this channel is not location-based, the effect being that it can be received and participated in by user in any location covered by the system. If desired, the user could limit the channel, for example, to only Chicago-based users.

In another embodiment, shown in FIG. 6, a user when specifying his profile (or after specifying his profile), can specify the priority at which selected channels are presented to his user interface. Thus, includable in the user profile set up screen are additional touch screen buttons 119 which allow the user to set priorities of the channels he wishes to receive. In this embodiment, the user 26b can set priorities by touching the touch screen buttons in the order of desired priority. Thus, in the example of FIG. 6, user 26b has depressed the button next to “receive emergency” first to specify that it is of the highest priority and the button is then redisplayed with the number “1” to indicate this fact. Next, the “receive traffic” button 119 is touched to the same effect, thus designating it as having the second-highest priority, and the same for weather, which has the third-highest priority. Other buttons 119 are not selected, specifying equally low (fourth) priority. Of course, many different ways exist to enter such desired priorities into the user profile, and the method shown in FIG. 6 is merely illustrative.

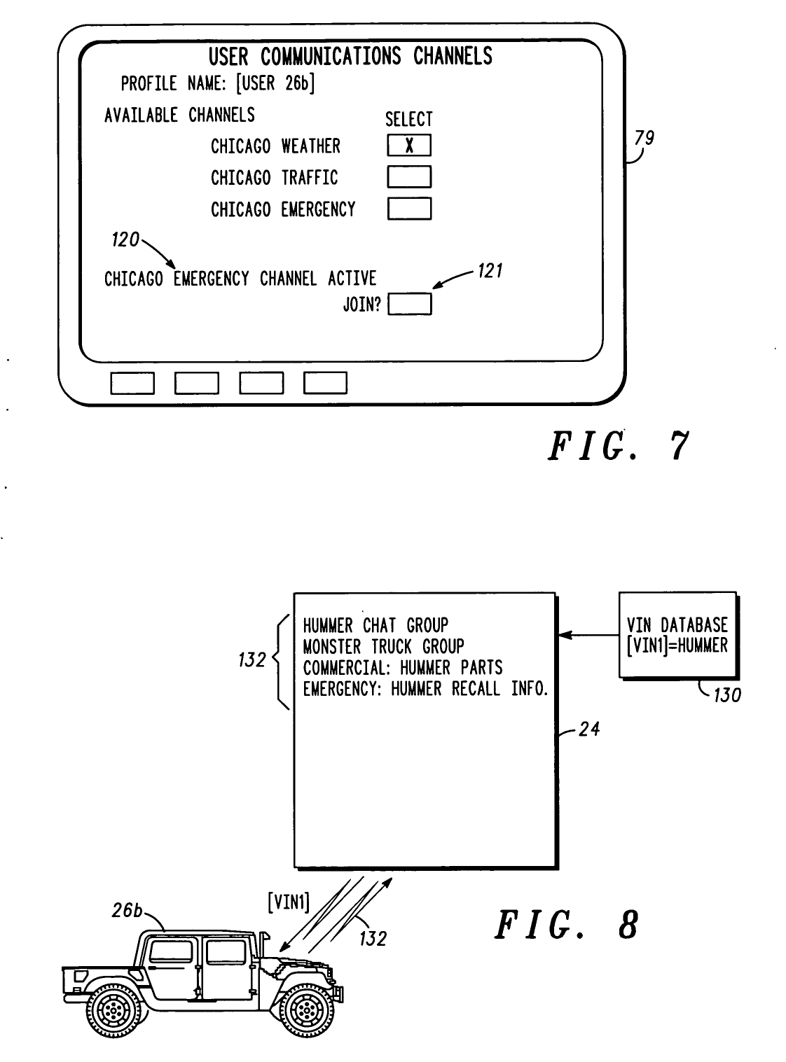

Once priorities are entered, the user can be notified when a higher priority channel is active. In this regard, it should be noted that a given specified channel may not necessarily be active, i.e., broadcasting information from services or other user at a given point in time. The server 24 can track when communications are occurring along a channel and inform affected users (i.e., those who have specified to receive a particular channel from their user profile) accordingly. This is shown in FIG. 7, in which user 26b was communicating along the Chicago weather channel, otherwise his third priority choice (see FIG. 6). Upon determining activity along the Chicago emergency channel (user 26b's highest priority), the server 24 may send a notification message 120 notifying at least those users who specified a preference to receive communications on this channel, along with a touch screen button 121 allow such users to join into the emergency channel and to leave or disconnect from their current channel. Alternatively, the connection to the original channel (e.g., Chicago weather) can be maintained, but merely reduced in volume when compares to the priority emergency channel. Notification 120 may also be audible in nature.

Certain priorities may be automatically dictated by the system. For example, emergency notification messages can always be broadcast from the server 24 to all users in the manner shown in FIG. 7, regardless of a particular user's specification of desired priorities. Moreover, it may not be necessary to provide a user the opportunity to join (e.g., 121) the emergency (or other priority) channel. Instead, the server 24 may send an interrupt command to affected users to automatically connect the emergency channel regardless of whether it has been joined or whether its user desires to join. The head unit 50 may further be configured to automatically turn on and activate the user interface 51 if a specific emergency notification is being used.

In a further embodiment, the user interface 51 may include an input for allowing a user to specify key words or terms for the server 24 to seek or monitor in other communication channels. For example, a user may specify that the server 24 monitor available channels for the word(s) “accident” and/or “Highway 190.” If the server 24 determines that those word(s) are being used on a specific channel, the server 24 may send a notification message notifying the user that a specified word(s) was being used on a communication channel. The user interface 51 would then allow the user to join in the identified communication channel. Alternatively, the server 24 could automatically add the user to the identified communication channel, or merely reduce the volume of an existing channel compared to the identified communication channel containing a discussion that uses the specified word(s).

While one's user profile can be set by the user on the basis of topical or other communication preferences, other aspects of one's profile can be based on information from the user vehicle and/or his user interface and which is specific to the vehicle and/or the user interface. Such information can be used by the server 24 to assist in providing relevant communication channels to the user, perhaps in conjunction with preferences specified by the user in his profile. For example, along with or in lieu of sending the user profile to the server 24, and as shown in FIG. 8, the Telematics control unit 40 may send the Vehicle Identification Number (VIN) to the server 24 as part of its data header. This VIN number can be used by the server 24 to determine the type of car user 26b is driving, and can therefore provide communication channels to that user potentially of interest. For example, suppose the server 24 has access to (or contains) a VIN database 130 associating VIN numbers with particular car models. The user's VIN number (e.g., [VIN1]) can be used by the server to look up the user's car model, in this case a Hummer. The server 24 can then query the available communication channels it supports to see which if any might be pertinent to that vehicle model. Suppose the query yields four channels 132 potentially of interest given their relevance to the vehicle model. These channels can then be presented to user 26b in the same manner illustrated in FIG. 4b. Such presentation can be automatic on the basis of the VIN number, or may be done in conjunction with the user's specified user profile. For example, even if a user has not specified to receive for example commercial channels (e.g., advertising concerning Hummer Parts), the Hummer Parts channel might still be presented to the user initially to query the user's interest. If the user specifies no interest (e.g., 139, FIG. 4b), that particular channel can be omitted from further broadcasts to that user.

The VIN provides just one example of data associated with a user interface that can be used by the system to tailor communications. In other examples, other data uniquely associated with particular interfaces, or types of interfaces, may be used to tailor communications to similar effect.

Although user preferences, and channel selection, have been disclosed herein as being controlled from the user's side, such functionality can also be performed on the server 24 side. For example, once the preferential attribute of a particular channel have been specified (e.g., as shown in FIG. 5, the server 24 may scan for user for which the channel seems a good match. In this regard, the users would still specify their preferences and transmit them to the server, the difference being that suitable channels would not be presented to the users until the server 24 received user preferences and has determined a suitable match. Thereafter, the channel would be presented to the relevant users.

Although the disclosed techniques are believed particularly useful to the processing and organization of voice data along communication channels, the disclosed techniques also have applicability to other forms of communication, such as text, data, and/or video communication.

Moreover, while largely described with respect to improving communications within vehicles, one skilled in the art will understand that many of the concepts disclosed herein could have applicability to other portable communicative user interfaces not contained within vehicles, such as cell phones, personal data assistants (PDAs), portable computers, etc., what can be referred to collectively as portable communication devices.

Although several discrete embodiments are disclosed, one skilled in the art will appreciate that the embodiments can be combined with one another, and that the use of one is not necessarily exclusive of the use of other embodiments. Moreover, the above description of the present invention is intended to be exemplary only and is not intended to limit the scope of any patent issuing from this application. The present invention is intended to be limited only by the scope and spirit of the following claims.

1. A communication network accessible by a first user using a first user interface, comprising:
a remote server in wireless communication with a first user interface for processing a plurality of a communication channels to allow a first user at the first user interface to communicate with other users without relevance of the location of the first user or the other users; and
wherein the server presents to the first user interface a subset of the plurality of channels to the first user for selection by the first user on the basis of a user profile created by the first user, wherein the user profile is indicative of the first user's communication preferences.

2. The network of claim 1, wherein the first user interface is positioned in a vehicle.

3. The network of claim 1, wherein the first user interface comprises a portable device.

4. The network of claim 1, wherein the first user interface is integral with a portable computer.

5. The network of claim 1, wherein the first user interface includes a display.

6. The network of claim 5, wherein the first user interface displays each of the presented channels for selection by the first user.

7. The network of claim 6, wherein the first user may reject certain of the presented channels.

8. The network of claim 1, wherein at least one the presented channels allows for two-way communications between the first user and another user.

9. The network of claim 1, wherein at least one the presented channels allows the first user to receive communications.

10. The network of claim 1, wherein the plurality of communication channels are data channels representing text and the first user interface includes a text to speech converter so that an output to the first user is an audible output of the text in the communication channels.

11. A method for processing a plurality of communication channels accessible by a first user at a first user interface, comprising:
presenting a plurality of channels from a server, wherein the channels carry two-way communication to permit a conversation between the first user and other users;
filtering the plurality of channels to selectively present at the first user interface a subset of the plurality of channels using a user profile created by the first user and without relevance of the location of the first user or other users wherein the user profile is indicative of the first user's communication preferences.

12. The method of claim 11, wherein the user interface is mounted within a vehicle and is in wireless communication with the server.

13. The method of claim 11, wherein the first user interface comprises a portable device.

14. The method of claim 11, wherein the first user interface includes a display.

15. The method of claim 14, wherein the first user interface displays each of the presented channels for selection by the first user.

16. The method of claim 15, wherein the first user may reject certain of the presented channels.

17. The method of claim 11, wherein at least one the presented channels allows for two-way communications between the first user and another user.

18. The method of claim 11, wherein at least one the presented channels allows the first user to receive communications.

19. The method of claim 11, wherein the plurality of communication channels are data channels representing text and the first user interface includes a text to speech converter so that an output to the first user is an audible output of the text in the communication channels.

20. A method of defining a group in a communication network accessible by a plurality of users each using user interfaces, comprising:
allowing a first user to define a first group at his first user interface on the basis of at least one user preference;
without regard to the location of either the first user or the other users, allowing other users to use their user interfaces to join the group upon selection of the first group from a plurality of other groups and after reviewing the user preference; and
permitting users that have joined the first group to talk with each other by pushing a button coupled to their user interfaces.

21. The method of claim 20, wherein the first user interface is positioned in a vehicle.

22. The method of claim 20, wherein the first user interface is integral with a portable device.

23. The method of claim 21, wherein the vehicle contains a controller, a microphone, a speaker, and a Telematics control unit, the controller being configured to only permit audio from the microphone to be transmitted through the Telematics control unit to the first group when the users push the button and is configured to only permit audio received from the first group to be heard over the speaker when the users are not pushing the button.

24. The method of claim 21, wherein the vehicle contains a controller, a microphone, a speaker, and a Telematics control unit, the controller being configured to only permit audio from the microphone to be transmitted through the Telematics control unit to the first group when the user pushes the button a first time and is configured to only permit audio received from the first group to be heard over the speaker when the user pushed the button a second time.

25. The method of claim 21, wherein the vehicle contains a controller, a microphone, a speaker, and a Telematics control unit, the controller including a voice activation circuit that is configured to only permit audio from the microphone to be transmitted through the Telematics control unit to the first group when the user speaks.

26. The method of claim 20, wherein the first user interface includes a display.

27. The method of claim 20, wherein the first user defines the group by selecting at least one option on the first user interface.

28. A method for processing a plurality of communication channels accessible by a first user at a first user interface, comprising in no particular order:
presenting a plurality of communication channels from a server;
filtering the plurality of channels to selectively present at the first user interface a subset of the plurality of channels in accordance with a user profile created by the first user; and
prioritizing the presentation of the channels at the user interface using the user profile.

29. The method of claim 28, wherein the first user interface is positioned in a vehicle.

30. The method of claim 28, wherein the first user interface is integral with a portable device.

31. The method of claim 28, wherein the first user interface comprises a portable computer.

32. The method of claim 28, wherein the first user interface includes a display.

33. The method of claim 32, wherein the first user interface displays each of the presented channels for selection by the first user.

34. The method of claim 28, wherein the priorities of the presented channels are specified at least in part by the first user.

35. The method of claim 28, wherein the priorities of the presented channels are specified at least in part by the server.

36. The method of claim 28, wherein priority is affected by providing the first user notice of a higher priority channel than the channel currently activated by the first user.

37. The method of claim 28, wherein prioritizing occurs prior to the step of filtering the plurality of channels.

38. The method of claim 28, wherein prioritizing occurs after the step of filtering the plurality of channels.

39. A method for processing a plurality of communication channels accessible by a first user at a first user interface, comprising:
presenting a plurality of first channels to a server, wherein the plurality of first channels contain two-way communications;
presenting at least one priority channel from the server;
presenting at least one of the plurality of first channels to the first user interface in accordance with a user profile created by the first user; and
preempting the presentation of the at least one of the plurality of first channels at the first user interface by presenting the priority channel to the first user interface.

40. The method of claim 39, wherein the at least one first channel is preempted by automatically disconnecting the first channel from the first user interface.

41. The method of claim 39, wherein the at least one first channel is preempted by reducing the volume of the first channel.

42. The method of claim 39, wherein the at least one first channel is preempted in accordance with preference specified by the first user at the first user interface.

43. The method of claim 39, wherein the at least one first channel is preempted by presenting a priority notification at the user interface.

44. The method of claim 43, wherein the first user can choose to select the priority channel after receiving the priority notification.

45. The method of claim 39, wherein the at least one first channel is preempted by immediately presenting the priority channel at the first user interface.

46. The method of claim 39, wherein the emergency channel is presented to the user interface as voice data.

47. The method of claim 39, wherein the emergency channel is presented to the user interface as graphical or textual data.

48. The method of claim 39, wherein the first user interface is positioned in a vehicle.

49. The method of claim 39, wherein the first user interface is integral with a portable device.

50. The method of claim 39, wherein the first user interface includes a display.

51. The method of claim 50, wherein the first user interface displays each of the presented channels for selection by the first user.

52. A method for processing a plurality of communication channels accessible by a first user at a first user interface, comprising:
presenting a plurality of channels at a server, wherein the channels contain communications;
presenting from the first user interface to the server data indicative of the first user interface; and
using, at the server, the data indicative of the first user interface to filter the plurality of channels to selectively present to the first user interface a subset of the plurality of channels.

53. The method of claim 52, wherein the first user interface is integral with a vehicle.

54. The method of claim 53, wherein the data indicative of the first user interface comprises a vehicle identification number.

55. The method of claim 53, wherein the presented channels relate to the type of vehicle.

56. The method of claim 52, wherein the first user interface includes a display.

57. The method of claim 56, wherein the first user interface provides a visual display of each of the presented channels for selection by the first user.

58. The method of claim 52, further comprising the step of using a user profile to further filter the plurality of channels presented at the first user interface.

59. A communication system in a vehicle for establishing a wireless communication channel, the communication system comprising:
a controller;
a user interface connected to the controller, the user interface having a switch, a microphone, a speaker, and a means for allowing a user in the vehicle to select from a plurality of wireless communication channels; and
a Telematics control unit in wireless communication with a remote server;
wherein the controller is configured to only allow audio from the microphone to be transmitted through the Telematics control unit to the remote server when the user presses the switch and is configured to only allow audio received from the remote server to be heard by the user when the user is not pressing the switch.

60. The method of claim 59, wherein the remote server is configured to receive a user profile created by the user.

61. The method of claim 60, wherein the remote server is configured to present the plurality of wireless communication channels based in accordance with the user profile created by the user.

62. The method of claim 61, wherein the remote server presents the plurality of wireless communication channels based on a priority associated with the user profile created by the user.
